(19) United States
(12) Patent Application Publication
(10) Pub. No.: US 2026/0175857 A1
(43) Pub. Date: Jun. 25, 2026

(54) Method for Operating an Assistance System for a Towing Vehicle of a Vehicle Combination for Carrying Out a Turning Maneuver, Computing Device, Computer-Readable Storage Medium, Assistance System, and Towing Vehicle

(71) Applicant: Bayerische Motoren Werke Aktiengesellschaft, Muenchen (DE)

(72) Inventor: Dominik HARTL, Muenchen (DE)

(21) Appl. No.: 19/127,395

(22) PCT Filed: Oct. 19, 2023
(86) PCT No.: PCT/EP2023/079084

§ 371 Date: May 5, 2025

(30) Foreign Application Priority Data
Nov. 18, 2022 (DE) 10 2022 130 623.2

(51) Int. Cl. B60W 50/14; B60W 30/06; B62D 13/06; B62D 15/02

(52) U.S. Cl. CPC B60W 50/14; B60W 30/06; B62D 13/06; B62D 15/027; B62D 15/028; B62D 15/0285

(57) ABSTRACT

A method for operating an assistance system for a towing vehicle to carry out a turning maneuver includes registering an operator input from a user of the towing vehicle, and executing the turning maneuver, at least in a partially automated manner, based on the operator input. The operator input includes instructions for the turning maneuver and describes a predefined target position for the turning maneuver.

### BACKGROUND AND SUMMARY

The disclosure relates to methods for operating an assistance system for a towing vehicle of a vehicle combination for carrying out a turning maneuver. The disclosure further relates to a computing device for a towing vehicle. Moreover, the disclosure still further relates to a computer-readable storage medium as well as to an assistance system for a towing vehicle of a vehicle combination. Finally, the still further relates to a towing vehicle.

Modern vehicles today feature numerous assistance systems that support the user of the vehicle in maneuvering, parking, and similar tasks. For example, modern vehicles are equipped with rear-view cameras or generate a so-called top-view image using multiple cameras. Additionally, modern vehicles may also take over longitudinal and/or lateral control during a parking process. So-called trailer assistants are also becoming increasingly popular for towing vehicles of a combination. Here, the user or driver of the combination can, for instance, continuously specify the articulation angle between the towing vehicle and the trailer during reversing using a rotary push controller, which significantly simplifies maneuvering with a vehicle combination.

Nevertheless, executing a turning maneuver presents particular challenges for the user of the towing vehicle. Often, multiple gear changes must be carried out, a frequently hard-to-see surrounding area must be monitored, and critical scenarios involving other road users must be anticipated. At the same time, applicable traffic regulations must be observed, and it must be assessed whether a turning maneuver with the vehicle combination is even possible within the available space. A turning maneuver thus presents specific challenges to the user of the towing vehicle and can consequently lead to stress and overwhelm.

Patent publication DE 10 2011 110 214 A1 describes a method and a corresponding device for turning a motor vehicle, wherein the motor vehicle comprises environment sensors for determining its surroundings. A contour of the drivable areas in the vehicle's surroundings is determined by means of the environment sensors, and a turning signal is generated when the determined contour indicates a turning area of sufficient size for a turning maneuver.

Published patent application DE 102015 008446 A1 relates to a method for operating a driver assistance system of a motor vehicle, comprising the following steps: determining a required time span for carrying out a turning maneuver of the motor vehicle on a roadway section being traveled on; detecting traffic conditions in an environment encompassing the drivable roadway section; checking, based on the determined traffic conditions, whether executing the turning maneuver on the roadway section is uncritical; and, if the execution of the turning maneuver is deemed uncritical, automatically carrying out the turning maneuver.

Document DE 102019 000447 A1 relates to a method for turning a vehicle, in which the surroundings of the vehicle are monitored, and a turning process is executed based on the monitoring of the surroundings. In a method designed to prevent dangerous situations, the turning process of the vehicle is automatically executed after a signal is entered.

Patent publication DE 10065230 A1 discloses a method and a system, in particular a control and/or regulation device, for facilitating the maneuvering and/or reversing of a vehicle with a trailer. The vehicle comprises a steering angle measuring device for detecting the steering angle of the steerable axle of the vehicle, and a monitoring device, in particular a parking assistance device, that detects at least the near surroundings of the vehicle on the side facing the trailer. An evaluation unit, which evaluates the detected values, provides instructions for turning the steering wheel.

It is an object of the present invention to provide a solution for how the user of a towing vehicle can be supported in carrying out a turning maneuver beyond the existing state of the art.

This object is achieved at least by the methods, computing devices, computer-readable storage mediums, assistance systems, and by towing vehicles having the features of various embodiments described herein.

In the context of this document, the term “automated driving” is understood to mean driving with automated longitudinal and/or lateral control. Automated driving may, for example, refer to prolonged driving on highways or to time-limited driving during parking. The term “automated driving” encompasses automated driving at any level of automation. Example levels of automation include assisted, partially automated, conditionally automated, highly automated, and fully automated driving (in order of increasing automation). The five levels of automation listed above correspond to SAE Levels 1 through 5 of the SAE J 3016 standard (SAE—Society of Automotive Engineers) as of Apr. 30, 2021. In assisted driving (SAE Level 1), the system handles either longitudinal or lateral control in certain driving situations. In partially automated driving (SAE Level 2), the system takes over both longitudinal and lateral control in specific driving situations, but the driver must continuously monitor the system, as with assisted driving. In conditionally automated driving (SAE Level 3), the system takes over both longitudinal and lateral control in certain driving situations without the driver needing to continuously monitor the system, although the driver must be able to take over vehicle control within a certain time if prompted by the system. In highly automated driving (SAE Level 4), the system assumes full control of the vehicle in certain driving situations, even if the driver does not respond to a request to intervene, making the driver redundant as a fallback. In fully automated driving (SAE Level 5), the system is capable of performing all aspects of the dynamic driving task under any roadway and environmental conditions that a human driver can handle.

Furthermore, in the context of this document, the term “at least partially automated driving or maneuvering” is also understood to mean partially automated, conditionally automated, highly automated, or fully automated driving. In other words, the term “at least partially automated driving” refers to any level of automation starting from SAE Level 2.

A method for operating an assistance system for a towing vehicle of a vehicle combination for carrying out a turning maneuver comprises registering an operator input from a user of the towing vehicle, wherein instructions for the turning maneuver are provided by means of the operator input. In addition, the method comprises an at least partially automated execution of the turning maneuver depending on the operator input. For this purpose, the operator input describes a predefined target position for the turning maneuver.

The method can, for example, be carried out by means of a computing device. The computing device can be configured, for instance, as at least one electronic control unit of the towing vehicle, which includes one or more programmable processors. Additionally, the computing device may comprise a computer-readable storage medium on which a computer program is stored. In order to carry out respective method steps, such as receiving the operator input, the computer program may be executed on the computing device.

The vehicle combination may include a trailer and the towing vehicle. The towing vehicle can, for example, be configured as a passenger car. Furthermore, the towing vehicle may also be a truck, a commercial vehicle, a self-propelled work machine, a motorhome, or the like. In particular, the towing vehicle may also be a tractor, an agricultural or forestry towing vehicle, a semi-trailer truck, a bus, or the like.

The trailer may be configured, for example, as a simple passenger car trailer, which may have both an overrun brake and its own service brake. Additionally, boat trailers, caravans, horse trailers, semi-trailers, a harvesting machine, or the like are also conceivable. In general, the steering technology of the trailer is irrelevant. In particular, it may therefore be an unsteered trailer (rigid axle). Additionally, the trailer may also have a pivot axle steering or a turntable steering system.

The method thus serves to assist the user of the towing vehicle in operating the assistance system to carry out the turning maneuver. The user of the towing vehicle may be, for example, the driver of the towing vehicle or a passenger of the towing vehicle. It is also conceivable that the user of the towing vehicle is a person located outside the towing vehicle, using a remote control to teleoperate the towing vehicle or the vehicle combination. The user of the towing vehicle may input the operator command, for instance, using a touchscreen display, voice control, gesture control, gaze control, or a conventional control element. Examples of conventional control elements include a so-called rotary push controller, a mirror adjustment device, a joystick, or the like. It is further conceivable that the operator input is entered via traditional push buttons. The latter is particularly conceivable if the input involves confirmation of the target position as the operator input or as part of the operator input.

The turning maneuver is typically intended to change the forward driving direction of the towing vehicle by 180°. However, it may also be advantageous if the orientation of the towing vehicle and the orientation of the trailer (for example, by specifying the articulation angle between trailer and towing vehicle) can be individually adjusted for each situation. In other words, it may be advantageous if the forward driving direction of the towing vehicle differs from the initial situation by, for example, 150 to 210° after the turning maneuver has been carried out. For example, the forward direction of the towing vehicle after completing the turning maneuver may differ by 160° from the vehicle's initial orientation. At the same time, the trailer's orientation may differ by only 140° from its initial orientation, whereby the articulation angle may then be 20° (assuming the articulation angle was 0° in the starting position). Overall, this may facilitate continued driving for the user of the towing vehicle after the turning maneuver. In addition, this allows the user to initiate the turning maneuver themselves, or carry out a first movement of the maneuver, and then be supported by the assistance system.

The operator input includes a predefined target position for the turning maneuver. The predefined target position may be the position that marks the end of the turning maneuver. It is also conceivable that the predefined target position is suggested by the assistance system. In such a case, the operator input may be a simple confirmation of the proposed target position. Alternatively or additionally, the predefined target position may be specified by the user of the vehicle. For this purpose, the control devices or control elements described above are suitable. In general, the target position may describe a position for the towing vehicle, the trailer, and an articulation angle between the towing vehicle and the trailer. The articulation angle of a vehicle combination—also called the combination angle—may describe the angle between a longitudinal axis of the towing vehicle and a longitudinal axis of a trailer. During straight-ahead driving of the vehicle combination, the articulation angle may be 0°. During a left turn, the articulation angle may be greater than 0°. During a right turn, the articulation angle may be less than 0°. The maximum absolute articulation angle—i.e. the angle at which jackknifing of the combination can just be prevented without a corrective maneuver—is also referred to as the jackknife angle.

Finally, the turning maneuver can be planned by the assistance system so that it ends in the predefined target position. To this end, the assistance system can plan the necessary trajectories and corresponding gear changes. The turning maneuver, which is to end in the predefined target position and is therefore executed based on the operator input, can then be carried out in an at least partially automated manner. For this purpose, it is conceivable that the assistance system or computing device communicates with a central control unit of the towing vehicle, and that the central control unit controls the actuators of the towing vehicle. It is also conceivable that functions of an additional trailer assistance system are used for this purpose.

In this context, it may be advantageous if a yaw angle is predefined for the target position of the turning maneuver. For example, the user of the towing vehicle may not necessarily wish to turn by 180°. Instead, in some situations, it may be helpful if the orientation of the towing vehicle after completion of the turning maneuver lies in an angular range of, for example, 150 to 210° relative to the starting position of the towing vehicle. In other words, it may be helpful if the predefined target position is specified in lateral and longitudinal direction, and additionally a yaw angle of the towing vehicle is specified for vehicle alignment or fine-tuning the driving direction.

For the user of the towing vehicle, the method provides an intuitive way to operate the assistance system for carrying out the turning maneuver. This can also help to reduce stress associated with the need for a turning maneuver. Furthermore, the continuation of travel after completing the turning maneuver can be made correspondingly easy for the user of the vehicle.

In this context, it may be advantageous if the target position of the turning maneuver includes a predefined articulation angle, wherein the predefined articulation angle describes an angle between the towing vehicle and a trailer coupled to the towing vehicle. A predefined articulation angle can offer the user additional convenience. It can make it easier to continue driving after the turning maneuver. Additionally, it can reduce the number of shunting maneuvers required for the turning maneuver. This can allow the turning maneuver to be carried out more quickly. As a result, additional stress for the user of the towing vehicle can be reduced.

Alternatively, it may also be advantageous if a coupling of a trailer to the towing vehicle is detected, and the predefined target position of the turning maneuver includes a predefined articulation angle that describes an angle between the towing vehicle and a trailer coupled to the towing vehicle, provided the coupling has been detected. If the predefined target position only includes a predefined articulation angle in this case, then the method can also be used during normal operation of the towing vehicle, i.e., during operation of the towing vehicle without a trailer.

The coupling of the trailer can be detected either manually or automatically. Automatic detection may occur, for example, by means of appropriate environment sensors of the towing vehicle (LiDAR, radar, and/or ultrasonic sensors and/or cameras). Additionally, automatic detection may also be accomplished via a corresponding plug connection through which the trailer is connected to the vehicle's electrical system. Overall, the assistance system for executing the turning maneuver can thus be used intelligently both with and without a trailer.

Another advantageous embodiment of the method provides that an environment model is also output, which describes a surrounding area of the towing vehicle and, based on that, the target position for the turning maneuver is specified and/or confirmed by the user of the towing vehicle.

Typically, the towing vehicle detects its environment by means of environment sensors. These sensors usually include radar, LiDAR, ultrasonic sensors, and/or cameras. The sensor data detected via these environment sensors may then be merged by the towing vehicle into an environment model. The environment model may then be used for planning trajectories and thereby for carrying out various assistance functions of the towing vehicle. The environment model may describe the surroundings of the vehicle. The environment model can, for example, be displayed to the driver or user of the towing vehicle on a display. When the user starts the assistance system for carrying out the turning maneuver, a predefined target position may be proposed and shown to the user on the display within the environment model. Using touch controls, the driver or user of the towing vehicle may adjust the predefined target position (optionally including the predefined articulation angle) within the environment model. In this way, the predefined target position can be described based on the environment model. In other words, the predefined target position can be described relative to the towing vehicle's own position, or relative to objects in the surroundings of the towing vehicle. This enables a simple operation of the assistance system for the user when carrying out the turning maneuver. The user of the towing vehicle can use the environment model for orientation and thus specify a desired position—where the turning maneuver should end—for the assistance system. This enables intuitive operation and therefore reduces stress for the user of the towing vehicle in an already challenging situation.

Furthermore, it may be advantageous if a target position proposal is also output, wherein the target position proposal constitutes an initial suggestion for the predefined target position and/or an initial suggestion for the predefined articulation angle of the predefined target position of the turning maneuver. For example, when the user of the towing vehicle starts the assistance system for executing the turning maneuver, a suggestion for a possible predefined target position of the turning maneuver may be presented to the user of the towing vehicle.

Such a suggestion for a predefined target position is known, for instance, from parking assistants. In such systems, after driving past a parking space, the space is proposed to the driver or user of the vehicle as a possible target position. If the user of the towing vehicle or the vehicle itself is on a two-lane roadway, a target position proposal describing a predefined target position on the adjacent lane can be output. Additionally, the target position proposal may include a suggestion for a predefined articulation angle. In the simplest case, the turning maneuver can thus be initiated immediately by confirming the suggestion. In this way, the user of the towing vehicle receives additional support in a challenging situation, saves time, and is spared from unnecessary operation or operator input.

In this context, it may also be advantageous if the predefined target position and/or the predefined articulation angle of the predefined target position is described through a modification of the target position proposal. By changing or adjusting the initial proposal for the predefined target position or the predefined articulation angle of the predefined target position, the user of the towing vehicle may be assisted in navigating within the environment model and thus in making the operator input. Additionally, modifying the target position proposal or the predefined articulation angle of the predefined target position can enhance the intuitiveness of the overall system. For example, if the environment model is displayed on a touchscreen, the user of the towing vehicle may be encouraged to interact with the touchscreen and thereby adjust the target position proposal.

Another advantageous embodiment of the method provides that an initial reachability check is carried out prior to executing the turning maneuver. In this check, it is verified whether the predefined target position can be reached in compliance with applicable traffic rules. Furthermore, this advantageous embodiment provides that a notification (to the user of the towing vehicle) is output based on the initial reachability check. When executing a turning maneuver with a towing vehicle and trailer, there are numerous traffic rules that must be observed. If the applicable rules for turning are disregarded, this may result in substantial fines. For example, if the predefined target position lies in an adjacent lane to the current lane occupied by the towing vehicle, and the two lanes are separated by a solid line, it would be prohibited to cross the lane boundary in order to perform the turning maneuver. Doing so would result in a fine, which may be significantly higher in the event of endangerment.

Lane boundaries or road markings are typically part of the environment model and are generally detected by a camera or LiDAR sensor. As part of the initial reachability check, it can therefore be assessed whether any planned trajectories violate applicable traffic rules. Particular attention must be given to the risk posed to other road users, any lane boundaries, direction indications via arrows or signs, and possible restricted zones. If the predefined target position cannot be reached without violating applicable traffic regulations, a notification can be issued. This ensures that the user remains actively involved in the current function sequence and is informed of any system limitations.

It may be advantageous if the turning maneuver can still be carried out following appropriate confirmation by the user of the towing vehicle. This is especially helpful when the user of the towing vehicle finds themselves in exceptional situations. Such confirmation may be given, for example, by tapping the accelerator pedal or simply acknowledging with an “OK” via an additional operator input. This allows, on the one hand, assurance that applicable traffic rules are observed by the assistance system, and on the other hand, enables the user of the towing vehicle to rely on the assistance system even in exceptional situations.

Another advantageous embodiment of the method provides that a continuous reachability check is carried out during the execution of the turning maneuver, in which it is verified whether the predefined target position is still reachable. If the predefined target position becomes unreachable, a corrected target position can be used as the predefined target position for the turning maneuver. A turning maneuver is usually carried out in multiple stages and takes place in a scenario that is subject to change. It may happen that, due to shifting positions of other road users or objects in the surrounding area, a new situation requiring reassessment arises during execution of the turning maneuver. For example, another road user might suddenly block the predefined target position during the turning maneuver. As a result, the turning maneuver may need to be aborted or paused.

Alternatively, however, the turning maneuver may also be continued with a corrected target position. In this context, it may be necessary to plan new trajectories and gear shifts. In the simplest case, however, the turning maneuver can be carried out as far as possible within the newly arisen situation. This can increase comfort for the user of the towing vehicle. Furthermore, a system abort can be prevented. Additionally, the user of the towing vehicle can be given the impression of artificial intelligence.

In this context, it may be advantageous if an object in the environment of the towing vehicle, which causes the predefined target position to become unreachable, is detected and characterized, and the corrected target position is determined based on the detected and characterized object. For example, if another road user blocks the predefined target position of the turning maneuver due to a temporary traffic jam, it can be advantageous if that road user is classified as only a temporary obstacle. Consequently, the turning maneuver can, for example, be paused. Once the brief traffic jam clears and the other road user no longer blocks the predefined target position, the turning maneuver can be resumed.

It may therefore be advantageous in this context if the detected and characterized object is at least classified as temporary or permanent. Based on this classification as temporary or permanent, the turning maneuver can either be paused or continued with a corrected target position. If the detected and characterized object in the environment of the vehicle is, for example, an illegally parked vehicle, then a corrected target position in front of, behind, or next to the detected and characterized object may be used as the predefined target position. In this way, the turning maneuver can still be carried out despite the presence of an obstacle that only became evident as such during the course of the maneuver. Overall, this can increase comfort for the user of the towing vehicle and thus improve the usefulness of the assistance system. Complex situations that require the towing vehicle or vehicle combination to perform a turning maneuver can thereby be managed on behalf of the user. As a result, stress can be reduced even in complex situations.

A computing device for a towing vehicle of a vehicle combination is configured to carry out the method and its advantageous embodiments. The computing device may, for example, be configured as an electronic control unit comprising one or more programmable processors.

A computer-readable storage medium comprises instructions which, when executed by a computing device, cause the computing device to carry out the method and its advantageous embodiments.

An assistance system for a towing vehicle of a vehicle combination comprises a computing device. Furthermore, an assistance system comprises a display-control device for a towing vehicle, which is configured to display an environment model output by the computing device and to detect an operator input from a user of the towing vehicle, wherein the operator input describes a predefined target position for a turning maneuver.

A towing vehicle comprises a trailer hitch and an assistance system. The vehicle may in particular be configured as a passenger car. The trailer hitch may be a pivotable, detachable, and/or rigid trailer hitch. It may also be a device for receiving a trailer hitch.

A further aspect relates to a computer program comprising instructions which, when the program is executed by a computing device, cause said computing device to carry out a method and its advantageous embodiments.

The preferred embodiments presented with reference to the method and their advantages also apply accordingly to the computing device, to the computer-readable storage medium, to the assistance system, and to the towing vehicle. Furthermore, the preferred embodiments and their advantages described with reference to the method also apply to the computer program.

Further features are evident from the claims, the figures, and the description of the figures. The features and feature combinations mentioned above in the description, as well as those mentioned below in the description of the figures and/or shown alone in the figures, may be used not only in the combinations explicitly stated but also in other combinations or in isolation, without departing from the scope of the invention.

One or more embodiments and aspects thereof will now be explained in more detail with reference to the accompanying drawings.

### BRIEF DESCRIPTION OF THE DRAWINGS

FIG. 1: a schematic view of a vehicle combination comprising a towing vehicle and trailer, wherein the towing vehicle includes an assistance system for executing a turning maneuver,

FIG. 2: a schematic view of a display-control device via which a user of the towing vehicle can specify a target position for the turning maneuver,

FIG. 3: a schematic view of the display-control device according to FIG. 2, via which the user of the towing vehicle can additionally specify an articulation angle for the predefined target position of the turning maneuver, and

FIG. 4: a schematic view of the execution of the turning maneuver.

### DETAILED DESCRIPTION OF THE DRAWINGS

In the figures, identical or functionally equivalent elements are denoted with the same reference numerals.

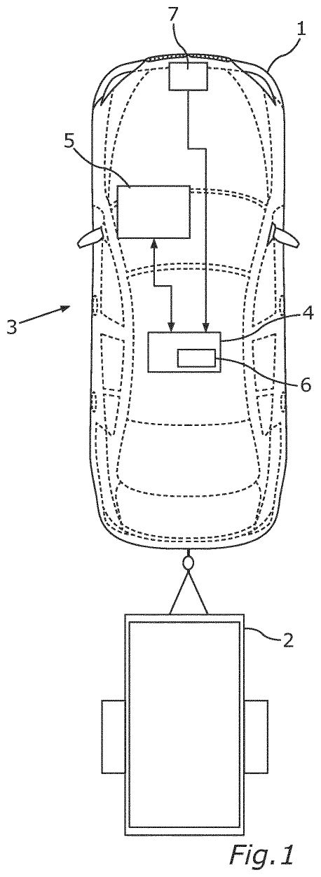

FIG. 1 shows a schematic view of a vehicle combination comprising towing vehicle 1 and trailer 2, wherein the towing vehicle 1 includes an assistance system 3 for executing a turning maneuver 10. The assistance system 3 comprises a computing device 4 and a display-control device 5. The computing device 4 further comprises a computer-readable storage medium 6, on which a computer program is stored. Finally, the towing vehicle 1 comprises an environment sensor 7.

The user 8 of the towing vehicle 1 can make an operator input using the display-control device 5. The operator input may describe a predefined target position 9 for the turning maneuver 10.

The computing device 4 can receive the operator input from the user 8 of the towing vehicle 1. Then, the assistance system 3, via the computing device 4, can plan a trajectory comprising possible changes in driving direction for the turning maneuver 10. Finally, the turning maneuver 10 can be carried out in an at least partially automated manner based on the operator input. The turning maneuver 10 may end at the predefined target position 9.

By means of the environment sensor 7 and optionally additional environment sensors, whose data may be fused, an environment model 11 can be provided. The environment model 11 can be displayed via the display-control device 5.

The computing device 4 may be an electronic control unit of the towing vehicle 1 comprising one or more programmable processors. The computing device 4 may also be a central computing device of the towing vehicle 1. Furthermore, the computing device 4 may be configured to control the actuators responsible for performing the longitudinal and/or lateral guidance of the towing vehicle 1.

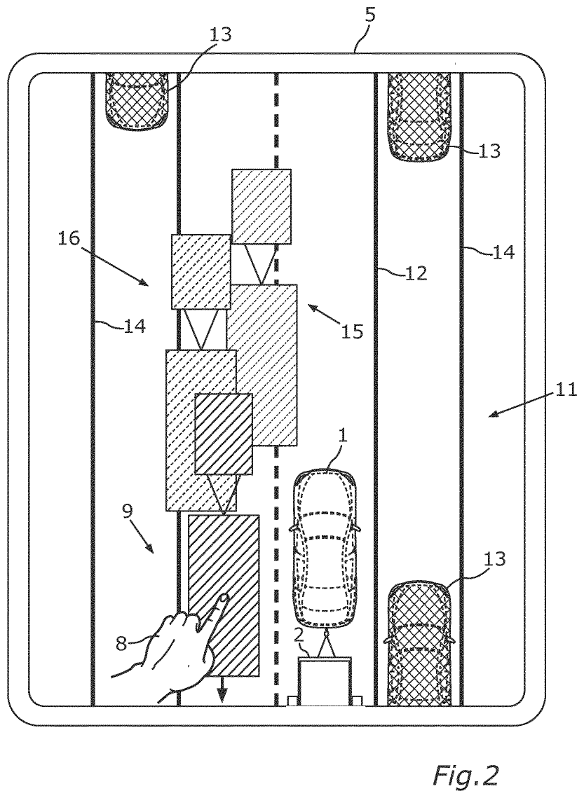

FIG. 2 shows a schematic representation of the display-control device 5, by means of which a user 8 of the towing vehicle 1 can specify a predefined target position 9 for the turning maneuver 10. The display-control device can be implemented as a touchscreen. On the display of the display-control device 5, an environment model 11 of the towing vehicle 1 is shown in FIG. 2. The environment model 11 may, for example, describe lane markings 12 and other road users 13. Furthermore, the environment model 11 may describe curb edges 14.

When the user 8 of the towing vehicle 1 starts the assistance system 3 for carrying out a turning maneuver 10, a target position proposal 15 can be output or displayed on the display of the display-control device 5. The user 8 of the towing vehicle 1 may adopt the target position proposal 15, which describes an initial suggestion for the predefined target position 9 and/or an initial suggestion for a predefined articulation angle φ of the predefined target position 9 of the turning maneuver 10, as the predefined target position 9, or modify the target position proposal 15 through a modification 16 to define the predefined target position 9 based on the environment model 11. The predefined articulation angle φ may describe an angle between a towing vehicle longitudinal axis 17 and a trailer longitudinal axis 18.

The arrow 9′ of the predefined target position 9 in the exemplary embodiment of FIG. 2 serves to illustrate the direction of travel after completing the turning maneuver 10. Typically, the driving direction after the turning maneuver 10 differs by 180° from the original driving direction of the towing vehicle 1. However, it may be advantageous if a yaw angle can be specified, for example, through a rotation gesture using two fingers on the touchscreen of the display-control device 5, so that the turning maneuver 10 defines a turning of the towing vehicle 1 in such a way that the orientation of the towing vehicle 1 after completing the turning maneuver 10 differs from the starting position by, for example, 150°, 160°, 170°, 180°, 190°, 200°, or 210°. Corresponding intermediate steps with a step size of one or five degrees are also conceivable.

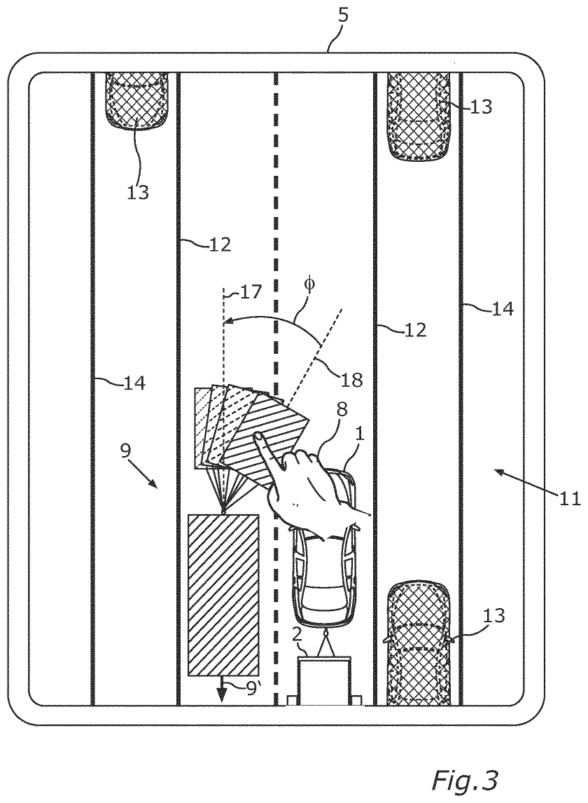

FIG. 3 shows a schematic representation of the display-control device 5 according to FIG. 2, where the user 8 of the towing vehicle 1 additionally specifies an articulation angle φ for the predefined target position 9 of the turning maneuver 10. Here, for example, following the actual specification of the predefined target position 9, the user 8 can define the articulation angle φ for the predefined target position 9 of the turning maneuver 10 by performing a rotational/swiping gesture with two fingers. In this way, the predefined target position 9 together with the articulation angle φ can be defined based on the environment model 11. In other words, the predefined target position 9 can be described relative to the towing vehicle's own position or the position of the towing vehicle 1, or relative to objects in the environment of the towing vehicle 1.

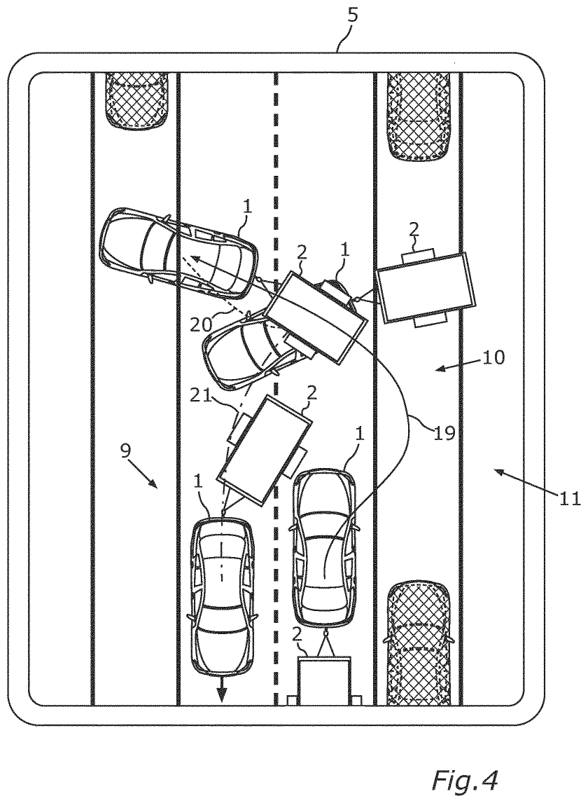

FIG. 4 shows a schematic representation of the display-control device 5 according to FIG. 2. Depending on the predefined target position 9, the trajectories 19, 20, 21 can be planned. To prepare the user 8 of the towing vehicle 1 for the upcoming turning maneuver 10, the turning maneuver 10 can be visualized (animated) on the display-control device 5.

1-14. (canceled)

15. A method for operating an assistance system for a towing vehicle to carry out a turning maneuver, comprising:
registering an operator input from a user of the towing vehicle, wherein instructions for the turning maneuver are provided by means of the operator input, and wherein the operator input describes a predefined target position for the turning maneuver, and
executing the turning maneuver in an at least partially automated manner based on the operator input.

16. The method of claim 15, wherein the predefined target position of the turning maneuver includes a predefined articulation angle that describes an angle between the towing vehicle and a trailer coupled to the towing vehicle.

17. The method of claim 16, further comprising:
outputting an environment model describing an environment of the towing vehicle, wherein the predefined target position and/or the predefined articulation angle is defined based on the environment model.

18. The method of claim 16, further comprising:
outputting a target position proposal that describes an initial suggestion for the predefined target position and/or an initial suggestion for the predefined articulation angle.

19. The method of claim 18, wherein the predefined target position and/or the predefined articulation angle is defined by means of a modification of the target position proposal.

20. The method of claim 19, further comprising:
detecting and characterizing an object in the environment of the towing vehicle that causes the predefined target position to be unreachable, and
determining the corrected target position based on the detected and characterized object.

21. The method of claim 15, further comprising:
detecting that a trailer is coupled to the towing vehicle, wherein the predefined target position of the turning maneuver includes a predefined articulation angle that describes an angle between the towing vehicle and the trailer.

22. The method of claim 15, further comprising:
carrying out an initial reachability check before executing the turning maneuver, wherein, during the initial reachability check, it is verified whether the predefined target position is reachable in compliance with applicable traffic regulations, and
outputting a notification based on the initial reachability check.

23. The method of claim 22, wherein the detected and characterized object is at least classified as temporary or permanent.

24. The method of claim 15, further comprising:
carrying out a continuous reachability check during execution of the turning maneuver, wherein, during the continuous reachability check, it is verified whether the predefined target position continues to be reachable, and
using a corrected target position in lieu of the predefined target position for the turning maneuver if the predefined target position is unreachable.

25. A computing device for a towing vehicle, wherein the computing device is configured to carry out the method of claim 15.

26. A non-transitory computer-readable medium storing instructions executable by a computing device to carry out the method of claim 15.

27. An assistance system for a towing vehicle, the assistance system comprising:
a computing device configured to carry out the method of claim 15; and
a display-control device configured to:
display an environment model output by the computing device, and
detect the operator input from the user.

28. A towing vehicle comprising:
a trailer hitch, and
an assistance system comprising:
a computing device configured to carry out the method of claim 15; and
a display-control device configured to:
display an environment model output by the computing device, and
detect the operator input from the user.
